(19) United States
(12) Patent Application Publication
(10) Pub. No.: US 2026/0029281 A1
(43) Pub. Date: Jan. 29, 2026

(54) ENVIRONMENTAL MEASURING DEVICE

(71) Applicant: DAIKIN INDUSTRIES, LTD., Osaka (JP)

(72) Inventors: Tsuyoshi ISAKA, Osaka (JP); Takehiko HIEI, Osaka (JP); Tomokage ASAKURA, Osaka (JP); Ayane ISHIDA, Osaka (JP)

(21) Appl. No.: 19/092,831

(22) Filed: Mar. 27, 2025

Related U.S. Application Data
(63) Continuation of application No. PCT/JP2023/028109, filed on Aug. 1, 2023.

(30) Foreign Application Priority Data
Sep. 30, 2022 (JP) 2022-157857

(51) Int. Cl. G01K 11/24; G01K 13/024

(52) U.S. Cl. CPC G01K 11/24; G01K 13/024

(57) ABSTRACT

An environmental measuring device includes a sound wave transceiver unit, a setter, and an estimator. The sound wave transceiver unit transmits and receives detection sound waves. The setter divides the target space into sections, and sets a first virtual mesh. The estimator estimates temperature or airflow distribution in the target space, based on a time of flight of the detection sound waves passing through a section of the first virtual mesh. The estimator estimates temperature or airflow in each of the sections of the first virtual mesh, using a predetermined prediction method and a constraint condition. The constraint condition includes at least one of a value representing temperature or airflow in a second virtual mesh having fewer sections than the first, an amount of air flowing in at least one section of the first virtual mesh, and at least one measured temperature value in the first virtual mesh.

### CROSS-REFERENCE TO RELATED APPLICATIONS

This is a continuation of International Application No. PCT/JP2023/028109 filed on Aug. 1, 2023, which claims priority under 35 U.S.C. § 119 (a) to Patent Application No. 2022-157857, filed in Japan on Sep. 30, 2022, all of which are hereby expressly incorporated by reference into the present application.

### BACKGROUND

### Technical Field

The present disclosure relates to environmental measuring device.

### Background Information

A method of generating a virtual mesh including a plurality of sections divided from a target space and obtaining a temperature and an airflow of the target space, based on a time of flight and a propagation distance of detection sound waves passing through each section of the virtual mesh is known as a method of measuring a temperature distribution or an airflow distribution in a target space (e.g., WO 2020/110393).

### SUMMARY

A first aspect is directed to an environmental measuring device that includes a sound wave transceiver unit, a setter, and an estimator. The sound wave transceiver unit is configured to transmit detection sound waves toward a target space, and receive detection sound waves. The setter is configured to divide the target space into a plurality of sections, and set a first virtual mesh including sections of the plurality of sections divided. The estimator is configured to estimate a temperature distribution or an airflow distribution in the target space, based on a time of flight of the detection sound waves passing through a predetermined section of the first virtual mesh. The estimator is configured to estimate a temperature or an airflow in each of the sections of the first virtual mesh, using a predetermined prediction method and a constraint condition in addition to the predetermined prediction method. The constraint condition includes at least one of a value representing a temperature or an airflow in a second virtual mesh having a smaller number of sections than the first virtual mesh, an amount of the air flowing into and out of at least one of the sections of the first virtual mesh, and at least one measured temperature value in the first virtual mesh.

### BRIEF DESCRIPTION OF THE DRAWINGS

FIG. 1 is a block diagram showing a configuration of environmental measuring device according to an embodiment.

FIG. 2 is a top view of a target space with a first virtual mesh set.

FIG. 3 is a top view of the target space with a second virtual mesh set.

FIG. 4 illustrates the rate of an airflow in an x-direction and a y-direction in each section.

FIG. 5 illustrates a fourth constraint condition.

FIG. 6 is a flowchart showing how to estimate a temperature distribution in the target space.

FIG. 7 is a flowchart showing how to estimate an airflow distribution in the target space.

FIG. 8 is a block diagram showing a configuration of environmental measuring device according to a variation.

FIG. 9 illustrates how to estimate a temperature distribution according to a variation.

### DETAILED DESCRIPTION OF EMBODIMENT(S)

An embodiment of the present disclosure will be described with reference to the drawings. The following embodiment is merely an exemplary one in nature, and is not intended to limit the scope, applications, or use of the present invention. Features of the embodiment, variation, and other examples described below can be combined or partially substituted within the range where the present invention can be embodied.

### (1) Environmental Measuring Device

Environmental measuring device (10) according to this embodiment measures the temperature distribution and the airflow distribution in a target space (S). The target space (S) is, for example, an office or a conference room in a building, a guest room or a banquet hall in a hotel, a room in a hospital, a storage room, such as a warehouse, or a room in an apartment or a detached house. In the following description, the target space (S) may be referred to as an indoor space (S). The indoor space (S) according to this embodiment is a quadrangular space with four wall surfaces as viewed from above. The indoor space (S) may include: an air conditioner for air-conditioning the indoor space (S); and a ventilator for ventilating the indoor space (S).

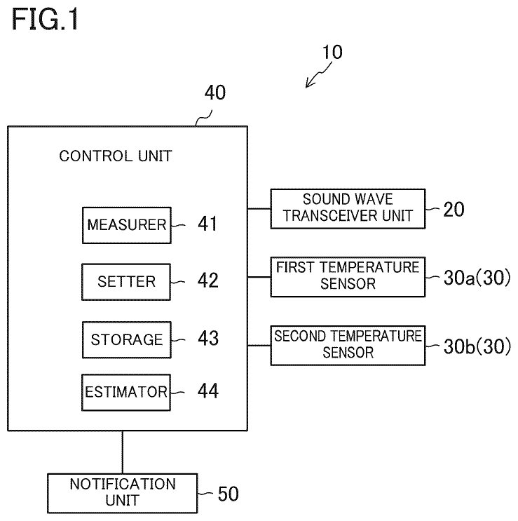

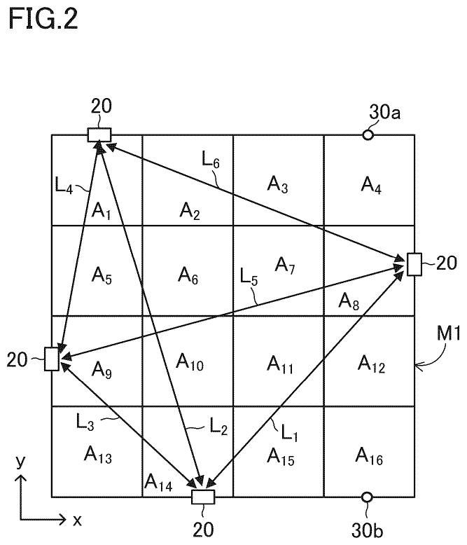

As shown in FIGS. 1 and 2, the environmental measuring device (10) according to this embodiment includes sound wave transceiver units (20), a temperature detection unit (30), a control unit (40), and a notification unit (50). The environmental measuring device (10) estimates the temperature distribution and the airflow distribution in the indoor space (S), based on the time of flight and the propagation distance of the detection sound waves to be transmitted to the indoor space (S).

### (2) Sound Wave Transceiver Unit

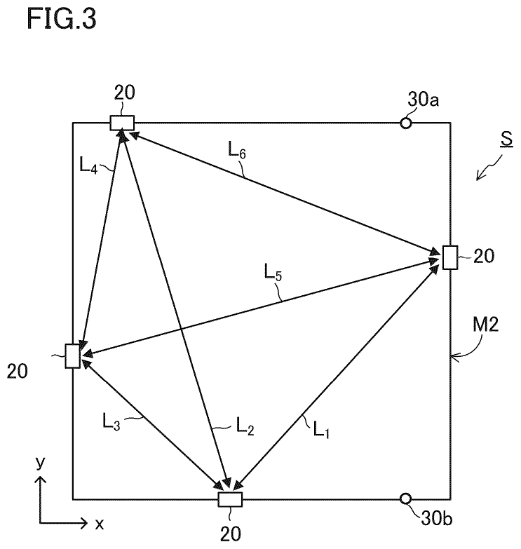

Each sound wave transceiver unit (20) includes: a transmitting section that transmits detection sound waves; and a receiving section that receives sound waves. Four sound wave transceiver units (20) are arranged in the indoor space (S). Specifically, each sound wave transceiver unit (20) is provided on one of the four wall surfaces of the indoor space (S) (see FIGS. 2 and 3).

Each sound wave transceiver unit (20) according to this embodiment includes, for the detection sound waves, the transmitting section and the receiving section integral with each other. Each sound wave transceiver unit (20) transmits and receives the detection sound waves at the same point. The four sound wave transceiver units (20) transmit and receive the detection sound waves to and from each other. Specifically, the detection sound waves transmitted by each sound wave transceiver unit (20) is received by the other three sound wave transceiver units (20).

The path through which the detection sound waves travels from one sound wave transceiver unit (20) to another sound wave transceiver unit (20) is referred to as a “propagation path”. In this embodiment, six sound wave propagation paths (L₁, L₂, . . . , L₆) are formed in the indoor space (S) (see FIG. 2). The lengths D (D₁, D₂, . . . , D₆) of the propagation paths correspond to linear distances between the sound wave transceiver units (20).

The time from when one sound wave transceiver unit (20) transmits detection sound waves to when another sound wave transceiver unit (20) receives the detection sound waves is referred to as a “Time of Flight (ToF)”. The time of flight is the time for the detection sound waves passing through the sound wave propagation path.

Each of the four sound wave transceiver units (20) has two ToFs (i.e., an outward time (t⁺) and a return time (t⁻)) for each sound wave propagation path in order to transmit and receive the detection sound waves to and from the other sound wave transceiver units. ToF may refer to the average of the outward time (t⁺) and the return time (t⁻). In this embodiment, the six ToFs (ToF₁, ToF₂, . . . , ToF₆) are associated with the propagation paths (L₁, L₂, . . . , L₆), respectively.

### (3) Temperature Detection Unit

The temperature detection unit (30) includes two temperature sensors. The two temperature sensors are namely, a first temperature sensor (30a) and a second temperature sensor (30b). The first temperature sensor (30a) and the second temperature sensor (30b) are provided at different points in the indoor space (S). Each temperature sensor (30) transmits a signal indicating the detected temperature value to the control unit.

### (4) Control Unit

The control unit (40) includes a microcomputer mounted on a control board, and a memory device (specifically, a semiconductor memory) that stores software for operating the microcomputer. The control unit (40) is connected to the temperature detection unit (30) and the notification unit (50) via communication lines. The control unit (40) includes a measurer (41), a setter (42), a storage (43), and an estimator (44).

The measurer (41) measures the respective times of flight ToFs of the detection sound waves through the propagation paths (L₁, L₂, . . . , L₆) from when one sound wave transceiver unit (20) transmits the sound waves to when another sound wave transceiver unit (20) receives the sound waves.

As shown in FIGS. 2 and 3, the setter (42) sets a first virtual mesh (M1) and a second virtual mesh (M2). The virtual mesh (M) includes a plurality of sections divided from the indoor space (S) as viewed from above. Specifically, the virtual mesh is obtained by dividing the indoor space (S) into a plurality of sections horizontally and vertically. The first virtual mesh (M1) according to this embodiment has 16 sections (4 in the vertical direction×4 in the horizontal direction). The second virtual mesh (M2) has a smaller number of sections than the first virtual mesh (M1). The second virtual mesh (M2) according to this embodiment has one section (1×1). In the following description, the horizontal direction of the indoor space (S) may be referred to the “x-direction” and the vertical direction of the indoor space (S) may be referred to as the “y-direction”.

The storage (43) stores the sound wave propagation paths, the lengths of the sound wave propagation paths, the times of flight of the sound waves, predictive models, which will be described later, and other data.

The estimator (44) estimates the temperature distribution and the airflow distribution in the indoor space (S), based on the time of flight of the detection sound waves through a predetermined section of the first virtual mesh (M1). Details of the estimator (44) will be described later.

### (5) Notification Unit

The notification unit (50) outputs the results of estimating the temperature distribution and the airflow distribution in the indoor space (S). The notification unit (50) is a display, for example. The user can check the result of estimating the temperature distribution and the airflow distribution in the indoor space (S) displayed on the display.

### (6) Estimation of Temperature Distribution and Airflow Distribution

The estimator (44) estimates the temperature and the airflow in each of the sections A₁ to A₁₆ of the first virtual mesh (M1), using a predetermined prediction method and a constraint condition in addition to the prediction method. The prediction method obtains the temperature and the airflow of the air in each section, based on the time of flight of the sound waves in each sound wave propagation path in the indoor space (S), the length of each sound wave propagation path passing through each section and the propagation speed of the sound waves through the section. If the airflow is obtained, the temperature is estimated in advance. This embodiment uses a generalized inverse matrix as the prediction method. The temperature distribution in the indoor space (S) measured by the environmental measuring device (10) of this embodiment will be described in detail below.

The propagation speed C of the sound waves is expressed by the following relational equation using a predetermined coefficient α and a temperature T, where v₀ is the sound speed (331.5 m/s) at 0° C.

$$\begin{matrix}Math 1 & \\ {v}_{n} = {v}_{0} + α \times {t}_{n} & ( Expression 1 )\end{matrix}$$

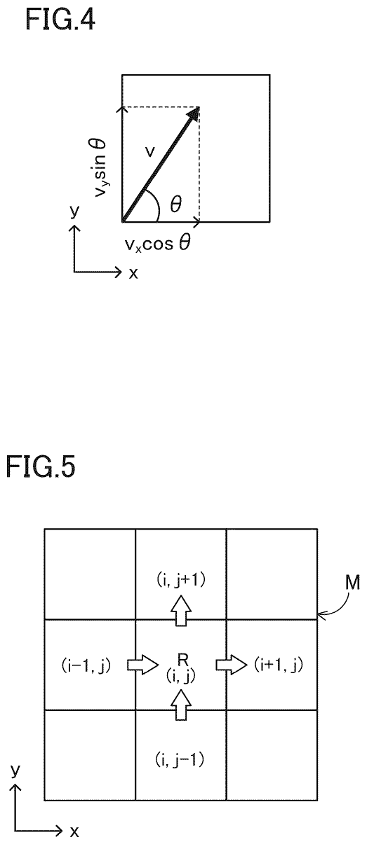

The round-trip times of the time of flight (ToF) of the detection sound waves are expressed by the following relational expression using the length D of the sound wave transmission path and the wind speed v. As shown in FIG. 4, vₓ cos θ represents the airflow rate in the x-direction, and v_{y} sin θ represents the airflow rate in the y-direction.

$$\begin{matrix}Math 2 & \\ {t}^{+} = \frac{D}{C} - \frac{D}{{C}^{2}} \times ( {v}_{x} cos θ + {v}_{y} sin θ ) & ( Expression 2 )\end{matrix}$$

$$\begin{matrix}Math 3 & \\ {t}^{-} = \frac{D}{C} + \frac{D}{{C}^{2}} \times ( {v}_{x} cos θ + {v}_{y} sin θ ) & ( Expression 3 )\end{matrix}$$

### (7) How to Estimate Temperature Distribution

A calculation formula for obtaining the temperature is obtained based on the sum of the round-trip time of flight of the sound waves. Specifically, the following relational equation holds based on Equations (1) to (3).

$$\begin{matrix}Math 4 & \\ \frac{1}{2} ( {t}^{-} + {t}^{+} ) = \frac{D}{C} = \frac{D}{{v}_{0} + α T} & ( Expression 4 )\end{matrix}$$

Based on Equation (4), the determinant of the first virtual mesh for obtaining the temperatures of the sections A₁ to A₁₆ is created. Specifically, for six sound waves passing through the sound wave propagation paths (L₁ to L₆), the following Determinant (5) holds between the six ToFs (ToF₁ to ToF₆) and the respective sound wave propagation distances D_{m, n}, where m is 1, 2, . . . , 6 and n is 1, 2, . . . , 16, and the respective sound speeds vₙ, where n is 1, 2, . . . , 16, in the sections A₁ to A₁₆.

$$\begin{matrix}Math 5 & \\ ( \begin{matrix}{ToF}_{1} \\ {ToF}_{2} \\ ⋮ \\ {ToF}_{6}\end{matrix} ) = ( \begin{matrix}{D}_{1 , 1} & {D}_{1 , 2} & … & {D}_{1 , 16} \\ {D}_{2 , 1} & {D}_{2 , 2} & … & {D}_{2 , 16} \\ & ⋮ & & \\ {D}_{6 , 1} & {D}_{6 , 2} & … & {D}_{6 , 16}\end{matrix} ) ( \begin{matrix}1 / {v}_{1} \\ 1 / {v}_{2} \\ ⋮ \\ 1 / {v}_{16}\end{matrix} ) & ( Expression 5 )\end{matrix}$$

### (7-1) Constraint Conditions

In this embodiment, if the first condition holds, the following two constraint conditions are added to Equation (5) to obtain the temperatures of the sections A₁ to A₁₆ using the generalized inverse matrix. The first condition holds if the following Expression (6) is satisfied, where P is the number of the sections of the first virtual mesh, and Q is the number of the sound wave transceiver units (20) provided in the indoor space (S).

$$\begin{matrix}Math 6 & \\ P > Q \times \frac{Q - 1}{2} & ( Expression 6 )\end{matrix}$$

### (7-1-1) First Constraint Condition

The first constraint condition corresponds to the temperature value in the second virtual mesh (M2). The temperature T_{AVG.} of the second virtual mesh (M2) is obtained based on Equation (4). The temperature T_{AVG.} represents the average temperature in the indoor space (S). That is, the temperature T_{AVG.} indicates the average of the temperatures of the 16 sections of the first virtual mesh. A predetermined arithmetic expression representing the temperature T_{AVG.} is added as the first constraint condition to Determinant (5).

### (7-1-2) Second Constraint Condition

The second constraint condition corresponds to the value measured by a temperature sensor (30) disposed in the indoor space (S). The second constraint condition corresponds to the temperature of a mesh provided with the temperature sensor (30). Since there are two temperature sensors in this embodiment, the second constraint condition corresponds to the temperature of the section provided with the first temperature sensor (30a) and the temperature of the section provided with the second temperature sensor (30b).

For example, assume that the first temperature sensor (30a) is disposed in the section A₄ and the second temperature sensor (30b) is disposed in the section A₁₆ (see FIG. 2). Assume that the temperature detected by the first temperature sensor (30a) is 20° C. and the temperature detected by the second temperature sensor (30b) is 21° C. At this time, a predetermined arithmetic expression for setting the temperature of the section A₄ to 20° C. and a predetermined arithmetic expression for setting the temperature of the section A₁₆ to 21° C. are added as the second constraint condition to Determinant (5).

In this manner, the estimator (44) obtains the temperatures of the sections A₁ to A₁₆, using the generalized inverse matrix with the first constraint condition and the second constraint condition added to Determinant (5). Accordingly, the estimator (44) estimates the temperature distribution in the indoor space (S).

### (8) How to Estimate Airflow Distribution

The respective temperatures of the sections are obtained in advance based on Equation (5). A calculation formula for obtaining the airflow is obtained based on the difference between the time of flight of the sound waves through the outward path and the time of flight of the sound waves through the return path. Specifically, the following relational equation holds based on Equations (1) to (3).

$$\begin{matrix}Math 7 & \\ \frac{1}{2} ( {t}^{-} - {t}^{+} ) {C}^{2} = D ( {v}_{x} cos θ + {v}_{y} sin θ ) & ( Expression 7 )\end{matrix}$$

Based on Equation (7), the determinant of the first virtual mesh (M1) for obtaining the respective airflows of the sections A₁ to A₁₆ is created. Specifically, for six detection sound waves passing through the sound wave propagation paths (L₁ to L₆), the following Determinant (8) holds between the six ToFs (ToF₁ to ToF₆) and the respective sound wave propagation distances D_{m, n}, where m is 1, 2, . . . , 6 and n is 1, 2, . . . , 16, and the respective sound speeds vₙ, where n is 1, 2, . . . , 16, in the sections A₁ to A₁₆.

$$\begin{matrix}Math 8 & \\ ( \begin{matrix}{ToF}_{1} \\ {ToF}_{2} \\ ⋮ \\ {ToF}_{6}\end{matrix} ) = ( \begin{matrix}{D}_{1 , 1} cos θ & … & \begin{matrix}{D}_{1 , 16} cos θ & {D}_{1 , 1} sin θ\end{matrix} & … & {D}_{1 , 16} sin θ \\ {D}_{2 , 1} cos θ & … & \begin{matrix}{D}_{2 , 16} cos θ & {D}_{2 , 1} sin θ\end{matrix} & … & {D}_{2 , 16} sin θ \\ & & ⋮ & & \\ {D}_{6 , 1} cos θ & … & \begin{matrix}{D}_{6 , 16} cos θ & {D}_{6 , 1} sin θ\end{matrix} & … & {D}_{6 , 16} sin θ\end{matrix} ) ( \begin{matrix}1 / {v}_{x 1} \\ 1 / {v}_{x 2} \\ ⋮ \\ 1 / {v}_{x 16} \\ 1 / {v}_{y 1} \\ 1 / {v}_{y 1} \\ ⋮ \\ 1 / {v}_{y 16}\end{matrix} ) & ( Expression 8 )\end{matrix}$$

### (8-1) Constraint Conditions

In this embodiment, if the second condition holds, the following two constraint conditions are added to Equation (8) to obtain the wind speeds of the sections A₁ to A₁₆ using the generalized inverse matrix. The second condition holds if the following Expression (9) is satisfied, where P is the number of the sections of the first virtual mesh, and Q is the number of the sound wave transceiver units (20) provided in the indoor space (S).

$$\begin{matrix}Math 9 & \\ P \times 2 > Q \times \frac{Q - 1}{2} & ( Expression 9 )\end{matrix}$$

### (8-1-1) Third Constraint Condition

The third constraint condition corresponds to the values of the wind speeds in the x- and y-directions in the second virtual mesh (M2). Based on Equation (7), the wind speed v_{AVG, x} in the x-direction and the wind speed v_{AVG, y} in the y-direction of the second virtual mesh (M2) are obtained. The wind speed v_{AVG, x} and the wind speed v_{AVG, y} represent the average wind speeds in the x- and y-directions of the indoor space (S), respectively. That is, the wind speed v_{AVG, x} represents the average of the wind speeds in the x-direction of the 16 sections of the first virtual mesh (M1), and the wind speed v_{AVG, y} represents the average of the wind speeds in the y-direction of the 16 sections of the first virtual mesh (M1). A predetermined arithmetic expression representing the wind speed v_{AVG, x} and the wind speed v_{AVG, y} is added as the third constraint condition to Determinant (8).

### (8-1-2) Fourth Constraint Condition

The fourth constraint condition corresponds to the amount of the air flowing into and out of at least one section of the first virtual mesh (M1). Specifically, the amount of the air flowing into one section of the virtual mesh M is equal to the amount of the air flowing out of the section. For example, as shown in FIG. 5, the Relational Equation (10) holds, where v(I, j)ₓ represents the wind speed in the x-direction of the central section R(I, j) and v(I, j)_{y} represents the wind speed in the y-direction, because the air flowing into and out of the central section R(I, j) in the horizontal direction and the vertical direction is equal.

$$\begin{matrix}Math 10 & \\ 0 = {v ( i - 1 , j )}_{x} dy - {v ( i + 1 , j )}_{x} dy + {v ( i , j - 1 )}_{y} dx - {v ( i , j + 1 )}_{y} dx & ( Expression 10 )\end{matrix}$$

In this embodiment, the section corresponding to the central section R(I, j) described above is at least one of the section A₆, A₇, A₁₀, or A₁₁. In this embodiment, at least one of the four sections is selected. For the selected mesh, Equation (10) is added as the fourth constraint condition to Determinant (8).

In this manner, the estimator (44) obtains the wind speeds of the sections A₁ to A₁₆ in the x- and y-directions using the generalized inverse matrix with the third constraint condition and the fourth constraint condition added to Determinant (8). Accordingly, the estimator (44) estimates the airflow distribution in the indoor space (S).

### (9) Flow of Estimating Temperature Distribution and Airflow Distribution in Indoor Space

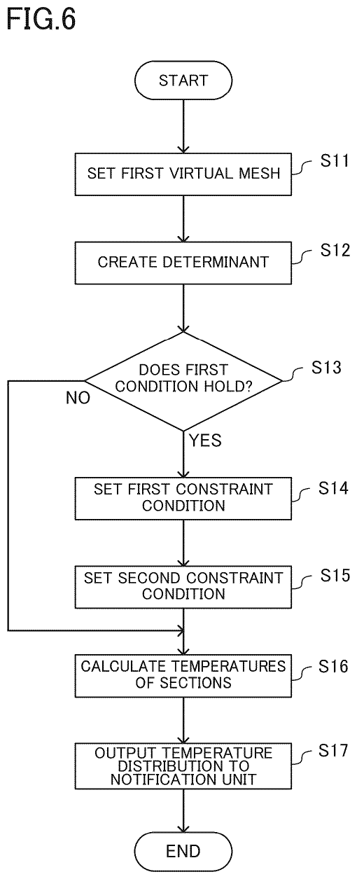

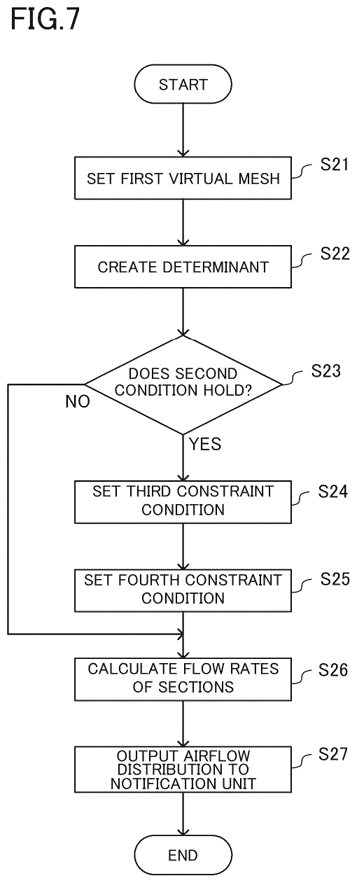

Next, a flow of estimating the temperature distribution and the airflow distribution in the indoor space (S), which is performed by the control unit (40), will be described with reference to FIGS. 6 and 7. The sound wave transceiver units (20) and the temperature sensors (30) are arranged at the points determined in advance. In order to estimate the airflow distribution, the temperature distribution is estimated in advance.

### (9-1) Flow of Estimating Temperature Distribution

In step S11, the control unit (40) sets the first virtual mesh (M1) to the indoor space (S). In this embodiment, the indoor space (S) is divided into 16 (4×4) sections as viewed from above.

In step S12, the control unit (40) creates a determinant of the first virtual mesh (M1) for obtaining the temperatures of the sections A₁ to A₁₆ (see Equation (5)).

In step S13, the control unit (40) determines whether the first condition holds. If the first condition is determined to hold (YES in step S13), step S14 is executed. If the first condition is determined not to hold (NO in step S13), step S16 is executed.

In step S14, the control unit (40) sets the first constraint condition. Specifically, the second virtual mesh (M2) is set to the indoor space S. In this embodiment, the virtual mesh has one (1×1) section when the indoor space is viewed from above. The temperature of the second virtual mesh (M2) is regarded as the first constraint condition. The set first constraint condition is added to the determinant in step S12.

In step S15, the control unit (40) sets the second constraint condition. Specifically, the temperatures of the sections provided with the first and second temperature sensors (30a, 30b) are set as the second constraint condition. The set second constraint condition is added to the determinant in step S12.

In step S16, the control unit (40) calculates the temperatures of the sections by calculating the determinant using the generalized inverse matrix.

In step S17, the control unit (40) outputs, to the display, the temperature distribution in the indoor space (S), based on the temperatures of the meshes calculated in step S16.

### (9-2) Flow of Estimating Airflow Distribution

Step S21 is the same as step S11 of the above embodiment, and thus the description thereof will be omitted.

In step S22, the control unit (40) creates the determinant of a virtual mesh for obtaining the wind speeds of the sections A₁ to A₁₆ (see Equation (8)).

In step S23, the control unit (40) determines whether the second condition holds. If the second condition is determined to hold (YES in step S23), step S24 is executed. If the second condition is determined not hold (NO in step S23), step S26 is executed.

In step S24, the control unit (40) sets the third constraint condition. Specifically, the second virtual mesh (M2) of 1×1 is set to the indoor space (S). The wind speeds in the x- and y-directions of the second virtual mesh (M2) are set as the third constraint condition. The set third constraint condition is added to the determinant in step S22.

In step S25, the control unit (40) sets the fourth constraint condition. Specifically, under the fourth constraint condition, the amounts of the air flowing into and out of the selected section of the first virtual mesh (M1) are equal (see Equation (10)). The set fourth constraint condition is added to the determinant in step S22.

In step S26, the control unit (40) obtains the wind speeds of the meshes in the x- and y-directions by calculating the determinant using the generalized inverse matrix.

In step S27, the control unit (40) outputs, to the display, the airflow distribution in the indoor space (S), based on the airflows of the meshes calculated in step S26.

### (10) Features

### (10-1) Feature 1

The estimator (44) of the environmental measuring device (10) according to this embodiment estimates a temperature or an airflow in each of the sections of the first virtual mesh (M1), using a predetermined prediction method and a constraint condition in addition to the predetermined prediction method. The constraint condition includes at least one of a value representing a temperature or an airflow in a second virtual mesh (M2) having a smaller number of sections than the first virtual mesh (M1), the amount of the air flowing into and out of at least one of the sections of the first virtual mesh (M1), or at least one measured temperature value in the first virtual mesh (M1).

In this embodiment, the accuracy in measuring the temperature distribution or the airflow distribution in the entire target space (S) is improved by using a constraint condition in addition to the predetermined method.

### (10-2) Feature 2

The environmental measuring device (10) according to this embodiment uses a generalized inverse matrix as a predetermined prediction method. Using the generalized inverse matrix, the respective temperatures and airflows in the sections can be obtained even if the number of unknowns of the temperature or the airflow in the virtual mesh is larger than the number of equations based on the time of flight and the propagation distance of the detection sound waves through the section of the virtual mesh.

### (10-3) Feature 3

In the environmental measuring device (10) according to this embodiment, the measured temperature value as the constraint condition corresponds to the value measured by the temperature sensor (30) disposed in the indoor space (S). The actually measured temperature value of at least one section of the first virtual mesh (M1) can be regarded as the constraint condition.

### (11) Variation

Now, a configuration of environmental measuring device (10) according to a variation will be described, which is different from the environmental measuring device (10) according to the embodiment described above.

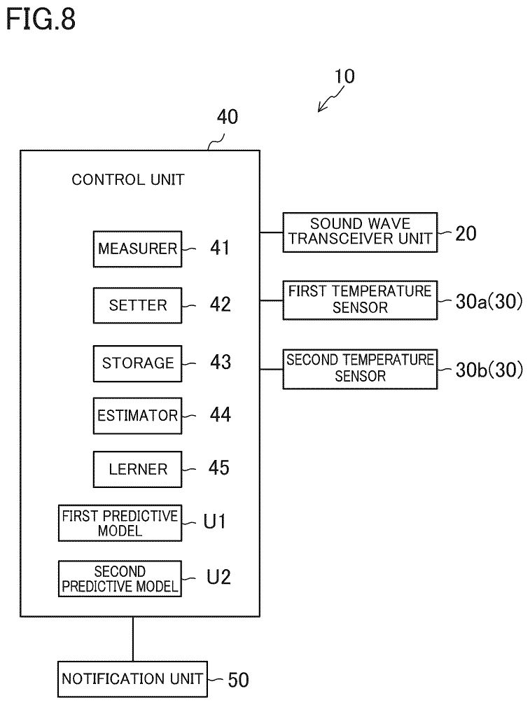

As shown in FIG. 8, the environmental measuring device (10) includes a learner (45), a first predictive model (U1), and a second predictive model (U2). The learner (45) learns, as training data, data indicating the time of flight of each sound wave propagation path in the indoor space (S) in association with the temperature distribution and the airflow distribution by machine learning.

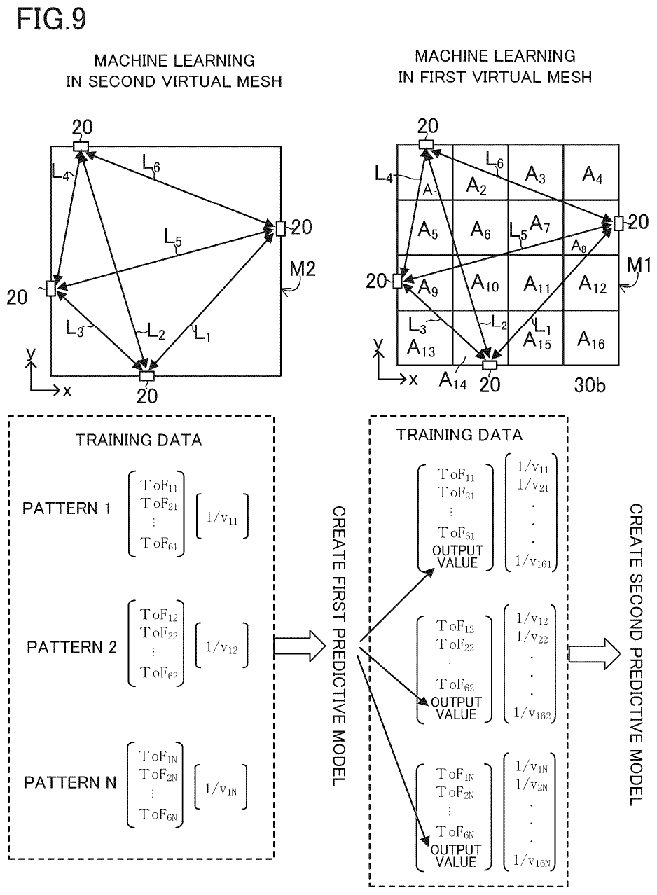

The learning of the temperature distribution will be described in detail with reference to FIG. 9. The learner (45) performs machine learning through simulation using the time of flight ToF and the sound speed v corresponding to each of the temperature distribution patterns (pattern 1 to pattern N) of the indoor space (S) as first training data. The sound speed v here is the sound speed in the second virtual mesh (1×1). For each temperature pattern, N patterns are learned with six ToFs (ToF₁ to ToF₆) and the corresponding sound speed v associated with each other. The learner (45) performs “supervised learning” using such learning data, thereby generating the first predictive model (U1) as a result of learning.

The learner (45) performs machine learning using, as second training data, learning data obtained with the value output from the first predictive model (U1) added to the first training data. The learner (45) performs machine learning using the value output from the first predictive model (U1), the times of flight ToFs and the sound speeds v corresponding to the plurality of temperature distribution patterns (pattern 1 to pattern N) of the indoor space (S) as first training data. The sound speed v here is the sound speed in the first virtual mesh (4×4). For each temperature pattern, N patterns are learned with six ToFs (ToF₁ to ToF₆) and the value output from the first predictive model added as the seventh data and the corresponding sound speeds v (v₁ to v₁₆) associated with each other. The learner (45) performs “supervised learning” using such learning data, thereby generating the second predictive model (U2) as a result of learning.

The estimator (44) estimates the temperature distribution in the indoor space (S) by inputting the actual six ToFs as input data into the second predictive model. The constraint condition according to the first variation corresponds to the value output from the first predictive model (U1). By adding, as the training data, this output value as the constraint condition, the accuracy in estimating the temperature distribution in the indoor space (S) can be improved. The method of estimating the airflow distribution according to the first variation is the same as the above-described method of estimating the temperature distribution, and thus description thereof will be omitted.

### (12) Other Embodiments

The above-described embodiment may be modified as follows.

In the embodiment and the variation, the second virtual mesh (M2) not necessarily has one section (1×1). The second virtual mesh (M2) may have the maximum number of the sections whose temperature or airflow is uniquely determinable without using any predetermined prediction method. For example, the second virtual mesh (M2) may have the maximum number of, that is, all the sections through which the propagation path of the detection sound waves passes.

In the variation described above, the constraint conditions are not necessarily used. Specifically, the estimator (44) creates a predictive model for outputting a temperature or an airflow of the first virtual mesh, based on a result of machine learning using, as training data, data indicating the time of flight of the detection sound waves through the propagation path in the indoor space (S) and the temperature distribution or the airflow distribution in association. The estimator (44) estimates the temperature distribution or the airflow distribution in the indoor space (S), using the predictive model with the time of flight through the propagation path in the indoor space (S) regarded as input data.

Specifically, the learner (45) performs machine learning using the time of flight ToF and the sound speed v corresponding to each of the temperature distribution patterns (pattern 1 to pattern N) of the indoor space (S) as first training data. The sound speed v here is the sound speed in the first virtual mesh (4×4). For each temperature pattern, N patterns are learned with six ToFs (ToF₁ to ToF₆) and the corresponding sound speeds v (v₁ to v₁₆) associated with each other. The learner (45) performs “supervised learning” using such learning data, thereby generating the predictive model as a result of learning.

In the above embodiment, one constraint conditions may be provided. If the temperature distribution is estimated, the constraint condition may include the first constraint condition or the second constraint condition. If the airflow distribution is estimated, the constraint condition may include the third constraint condition or the fourth constraint condition.

A constraint condition for estimating the airflow distribution may be added where the following three-dimensional airflow distribution condition is satisfied.

$$\begin{matrix}Math 11 & \\ P \times 3 > Q \times \frac{Q - 1}{2} & ( Expression 11 )\end{matrix}$$

In the above variation, the constraint condition is not limited to the value output from the virtual mesh of 1×1. For example, the learner (45) performs machine learning on a virtual mesh of 2×2 by adding, as training data, a value output from a virtual mesh of 1×1. The value output from the predictive model of the virtual mesh of 2×2 generated from the result of this learning may be set as the constraint condition. In this manner, in addition to the value output from the virtual mesh of 1×1, the value output from the virtual mesh of 2×2 is regarded as the constraint condition. In this manner, by generating machine learning and a predictive model in a stepwise manner in order of the virtual mesh of 1×1, the virtual mesh of 2×2, . . . , for a plurality of low-order meshes including a smaller number of sections than the first virtual mesh, the accuracy in estimating the temperature distribution and the airflow distribution in a higher-order virtual mesh is improved.

The measurer (41) is not necessarily provided in the control unit (40) but may be provided in the sound wave transceiver unit (20), or may be a device independent of other devices.

The environmental measuring device (10) may estimate a temperature distribution or an airflow distribution in the indoor space (S).

The control unit (40) according to the variation described above may have the first predictive model (U1) and the second predictive model (U2) in advance, or may generate them through learning each time.

While the embodiment and variation thereof have been described above, it will be understood that various changes in form and details may be made without departing from the spirit and scope of the claims. The embodiment and the variation thereof may be combined and replaced with each other without deteriorating intended functions of the present disclosure. The expressions of “first,” “second,” described above are used to distinguish the terms to which these expressions are given, and do not limit the number and order of the terms.

As described above, the present disclosure is useful for environmental measuring device.

1. An environmental measuring device comprising:
a sound wave transceiver unit configured to
transmit detection sound waves toward a target space, and
receive detection sound waves;
a setter configured to
divide the target space into a plurality of sections, and
set a first virtual mesh including sections of the plurality of sections divided; and
an estimator configured to estimate a temperature distribution or an airflow distribution in the target space, based on a time of flight of the detection sound waves passing through a predetermined section of the first virtual mesh,
the estimator being configured to estimate a temperature or an airflow in each of the sections of the first virtual mesh, using a predetermined prediction method and a constraint condition in addition to the predetermined prediction method, and
the constraint condition including at least one of
a value representing a temperature or an airflow in a second virtual mesh having a smaller number of sections than the first virtual mesh,
an amount of the air flowing into and out of at least one of the sections of the first virtual mesh, and
at least one measured temperature value in the first virtual mesh.

2. The environmental measuring device of claim 1, wherein
the estimator is configured to use a generalized inverse matrix as the prediction method in order to obtain the temperature or the airflow of air in each of the sections of the first virtual mesh, based on
the time of flight of the detection sound waves through the propagation path in the target space,
a length of the propagation path in the first virtual mesh, and
a propagation speed in the first virtual mesh.

3. The environmental measuring device of claim 1, wherein
the estimator is configured to
create a first predictive model to output a temperature or an airflow of the second virtual mesh, based on a result of machine learning using, as training data, data indicating the time of flight of the detection sound waves through the propagation path in the target space and the temperature distribution or the airflow distribution in association,
create a second predictive model to output a temperature or an airflow of the first virtual mesh, based on a result of machine learning using in addition to the training data, the constraint condition corresponding to a value output from the first predictive model, and
estimate the temperature distribution or the airflow distribution in the target space, using the second predictive model with the time of flight through the propagation path in the target space regarded as input data.

4. The environmental measuring device of claim 2, wherein
the estimator is configured to
create a first predictive model to output a temperature or an airflow of the second virtual mesh, based on a result of machine learning using, as training data, data indicating the time of flight of the detection sound waves through the propagation path in the target space and the temperature distribution or the airflow distribution in association,
create a second predictive model to output a temperature or an airflow of the first virtual mesh, based on a result of machine learning using in addition to the training data, the constraint condition corresponding to a value output from the first predictive model; and
estimate the temperature distribution or the airflow distribution in the target space, using the second predictive model with the time of flight through the propagation path in the target space regarded as input data.

5. The environmental measuring device of claim 1, wherein
the second virtual mesh has a maximum number of sections with temperature or airflow that is uniquely determinable without using the prediction method.

6. The environmental measuring device of claim 2, wherein
the second virtual mesh has a maximum number of sections with temperature or airflow that is uniquely determinable without using the prediction method.

7. The environmental measuring device of claim 3, wherein
the second virtual mesh has a maximum number of sections with temperature or airflow that is uniquely determinable without using the prediction method.

8. The environmental measuring device of claim 1, wherein
the at least one measured temperature value corresponds to a value measured by a temperature sensor disposed in the target space.

9. The environmental measuring device of claim 2, wherein
the at least one measured temperature value corresponds to a value measured by a temperature sensor disposed in the target space.

10. The environmental measuring device of claim 3, wherein
the at least one measured temperature value corresponds to a value measured by a temperature sensor disposed in the target space.

11. The environmental measuring device of claim 4, wherein
the at least one measured temperature value corresponds to a value measured by a temperature sensor disposed in the target space.

12. An environmental measuring device comprising:
a sound wave transceiver unit configured to
transmit detection sound waves toward a target space, and
receive detection sound waves; and
an estimator configured to
divide the target space into a plurality of sections, and
estimate a temperature distribution or an airflow distribution in the target space, based on a time of flight of the detection sound waves through a first virtual mesh including divided sections,
the estimator being configured to
create a predictive model to output a temperature or an airflow of the second virtual mesh, based on a result of machine learning using, as training data, data indicating the time of flight of the detection sound waves through the propagation path in the target space and the temperature distribution or the airflow distribution in association, and
estimate the temperature distribution or the airflow distribution in the target space, using the predictive model with the time of flight through the propagation path in the target space regarded as input data.
